(19) United States
(12) Patent Application Publication
(10) Pub. No.: US 2021/0252814 A1
(43) Pub. Date: Aug. 19, 2021

(54) PROCESSING METHOD FOR REFLECTIVE POLARIZATION MEMBER, AND REFLECTIVE POLARIZATION MEMBER

(71) Applicant: KABUSHIKI KAISHA TOKAI RIKA DENKI SEISAKUSHO, Aichi (JP)

(72) Inventor: Mitsuru NARUSE, Aichi (JP)

(73) Assignee: KABUSHIKI KAISHA TOKAI RIKA DENKI SEISAKUSHO, Aichi (JP)

(21) Appl. No.: 17/252,555

(22) PCT Filed: Jun. 17, 2019
(86) PCT No.: PCT/JP2019/023921

§ 371 Date: Dec. 15, 2020

(30) Foreign Application Priority Data
Jun. 18, 2018 (JP) 2018-115438

(51) Int. Cl. B29D 11/00; G02B 5/30

(52) U.S. Cl. CPC B29D 11/00644; G02B 5/3033

(57) ABSTRACT

A reflective polarization film includes a metal vapor deposition layer configured to allow passage of light having a polarization component parallel to a polarization axis and reflect light having a polarization component non-parallel to the polarization axis. By irradiating the reflective polarization film with laser light, a region where the metal vapor deposition layer is sublimated is formed so as to have a shape corresponding to a desired pattern. A polarization direction of the laser light is a direction non-parallel to the polarization axis.

### TECHNICAL FIELD

The present disclosure relates to a processing method for a reflective polarization member and the reflective polarization member obtained by the processing method.

### BACKGROUND ART

JP S61-025002 Y discloses a display switching apparatus using a polarization plate as an example of a polarization member.

The polarization member has a polarization axis that extends in a specific direction. Light having a polarization component parallel to the polarization axis is allowed to pass through the polarization member. In the following description, such light will be referred to as first polarized light. Light having a polarization component that is not parallel to the polarization axis is not allowed to pass. In the following description, such light will be referred to as second polarized light.

In the display switching apparatus, a plurality of polarization plates having different directions of polarization axes are arranged on a path of light emitted from a light source. Different transparent patterns are formed in the plurality of polarization plates. The term “transparent” in the following description means a property of allowing passage of both the first polarized light and the second polarized light. The term “pattern” in the following description is meant to include a graphic, a character, a symbol, a mark, a picture, and the like.

In the display switching apparatus, a polarization direction of incident light is switched so as to form the second polarized light for a specific polarization plate. Incident light only passes through a region where a pattern is formed in the specific polarization plate.

As a result, the pattern is visually recognized by the user. The polarization direction of the incident light is changed, so that the “specific polarization plate” can be changed, and a pattern provided for display to the user can be switched.

A polarization member that does not allow the second polarized light to pass therethrough by absorbing the second polarized light is referred to as an absorptive polarization member. The absorptive polarization member can be formed, for example, by stretching a polyvinyl alcohol (PVA) film substrate impregnated with an iodine compound in a specific direction and subjecting the film substrate to a crosslinking treatment.

A polarization member is also known which reflects the second polarized light so as not to allow transmission. Such a polarization member is referred to as a reflective deflection member. As an example of the reflective deflection member, a reflective deflection film in which metal is vapor-deposited on a film substrate having a grid structure is known. The film substrate is formed of triacetylcellulose (TAC), cyclo-olefin polymer (COP), or the like.

Examples of the metal to be vapor-deposited include aluminum, silver, and chrome.

As a method for forming the above-described pattern in the absorptive polarization member, it is known that a part of the substrate corresponding to a shape of the pattern is removed. On the other hand, a method for forming the above-described pattern in a reflective polarization member is not known.

### SUMMARY OF INVENTION

Thus, it is sought to make it possible to form a desired pattern in a reflective polarization member.

One aspect for satisfying the above-described demand provides a processing method for a reflective polarization member including a metal vapor-deposition layer that is configured to allow passage of light having a polarization component parallel to a polarization axis and to reflect light having a polarization component non-parallel to the polarization axis, the processing method including:

forming a region where the metal vapor-deposition layer is sublimated so as to have a shape corresponding to a desired pattern, by irradiating the reflective polarization member with laser light,

in which a polarization direction of the laser light is a direction non-parallel to the polarization axis.

According to the above-described configuration, sublimation efficiency of the metal vapor-deposition layer based on irradiation of the laser light can be increased. As a result, processing for forming the desired pattern in the reflective polarization member can be efficiently performed.

According to the above-described processing method, it is possible to provide a reflective polarization member including a metal vapor-deposition layer that is configured to allow passage of light having a polarization component parallel to a polarization axis and to reflect light having a polarization component non-parallel to the polarization axis, in which a region where the metal vapor-deposition layer is sublimated by laser light having a polarization component non-parallel to the polarization axis is shaped in a desired pattern.

### BRIEF DESCRIPTION OF DRAWINGS

FIG. 1 illustrates a configuration of a reflective polarization film according to an embodiment.

FIG. 2 illustrates a flow of a processing method for the reflective polarization film according to the embodiment.

FIG. 3 illustrates a principle of the processing method for the reflective polarization film according to the embodiment.

FIG. 4 illustrates a display apparatus including the reflective polarization film according to the embodiment.

### DESCRIPTION OF EMBODIMENTS

Examples of an embodiment will be described in detail below with reference to the accompanying drawings. In each drawing using the description hereinafter, a scale of each member is appropriately adjusted in order to show each member in a recognizable size.

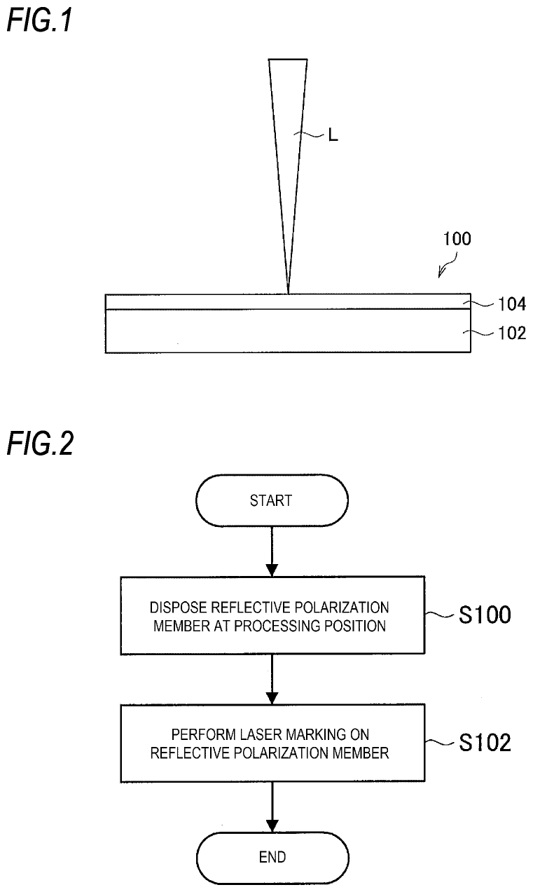

FIG. 1 illustrates a configuration of a reflective polarization film 100 according to an embodiment. The reflective polarization film 100 is an example of a reflective polarization member.

The reflective polarization film 100 includes a film substrate 102 and a metal vapor-deposition layer 104.

The film substrate 102 is made of TAC or COP. The film substrate 102 has polymer chains arranged in a specific direction. The metal vapor-deposition layer 104 is formed by vapor depositing a metal such as aluminum, silver, or chrome on one main surface of the film substrate 102. Accordingly, a dye is adsorbed on the polymer chains. As a result, the reflective polarization film 100 has a nano grid structure. The nano grid structure has a structure in which a plurality of grids that extend in a direction of the polymer chains are arranged in the specific direction at a nanometer interval.

The reflective polarization film 100 allows passage of light that oscillates in a direction orthogonal to an extending direction of the grids. In other words, the reflective polarization film 100 allows passage of light having a polarization component parallel to an arrangement direction of the plurality of grids. On the other hand, the reflective polarization film 100 does not allow passage of light that oscillates in a direction parallel to the extending direction of the grids. In other words, the reflective polarization film 100 does not allow passage of light having a polarization component orthogonal to the arrangement direction of the plurality of grids. That is, it can be said that a polarization axis of the reflective polarization film 100 extends in the arrangement direction of the plurality of grids.

In order to form a specific pattern in the reflective polarization film 100 having the above-described configuration, as illustrated in FIG. 1, the metal vapor-deposition layer 104 is irradiated with laser light L emitted from a light source (not shown).

The metal vapor-deposition layer 104 at a portion irradiated with the laser light L is sublimated. Accordingly, a region where the metal vapor-deposition layer 104 is absent is formed on the film substrate 102.

As described above, the reflective polarization film 100 does not allow passage of the light having the polarization component orthogonal to the arrangement direction of the plurality of grids. However, light incident on the region where the metal vapor-deposition layer 104 is absent (that is, a region where only the film substrate 102 exists) is allowed to pass regardless of a polarization direction thereof. Light that passes through the region is visually recognized, so that a pattern corresponding to a shape of the region is provided for display.

Therefore, by appropriately controlling an irradiation position of the laser light L, a region where the metal vapor-deposition layer 104 is removed can be formed so as to correspond to a shape of a desired pattern. In the following description, irradiation with the laser light L for forming the desired pattern is referred to as “pattern formation”. The pattern formation is an example of processing performed on the reflective polarization member.

Intensity of the laser light L is determined such that the metal vapor-deposition layer 104 can be sublimated and an amount of heat that does not cause a reaction to the film substrate 102 can be supplied. Such an amount of heat can be appropriately adjusted based on an output of the light source of the laser light L, a distance between the light source and the reflective polarization film 100, a pattern formation speed, and the like.

FIG. 2 illustrates a pattern formation procedure performed on the reflective polarization film 100.

First, the unprocessed reflective polarization film 100 is disposed at a predetermined position (S100). The predetermined position is a position where the laser light L can be emitted so as to form the desired pattern in the reflective polarization film 100.

Examples of the predetermined position include a position where the reflective polarization film 100 can be conveyed by an apparatus such as a belt conveyor or a robot arm. In this case, the reflective polarization film 100 can be disposed at the predetermined position by the apparatus. Arrangement of the reflective polarization film 100 at the predetermined position may be performed manually.

Subsequently, the pattern formation is performed on the reflective polarization film 100 disposed at the predetermined position (S102). The pattern formation is performed while at least one of the intensity of the laser light L, the irradiation position, and the irradiation direction is appropriately controlled.

As described above, the reflective polarization film 100 allows passage of light having a polarization component parallel to own polarization axis, but does not allow passage of light having a polarization component orthogonal to own polarization axis. Therefore, when a polarization direction of the laser light L is parallel to the polarization axis of the reflective polarization film 100, sublimation efficiency of the metal vapor-deposition layer 104 due to the irradiation of the laser light L decreases.

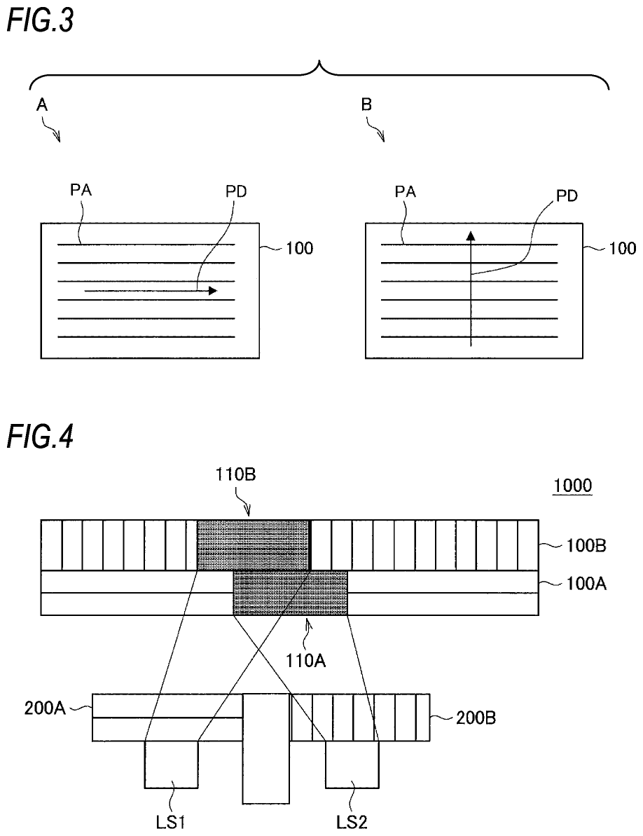

A reference numeral A in FIG. 3 schematically illustrates such a case. A reference numeral PA represents the polarization axis of the reflective polarization film 100. A reference numeral PD represents the polarization direction of the laser light L.

In the present embodiment, irradiation with the laser light L for the pattern formation is performed such that the polarization direction PD of the laser light L is non-parallel to the polarization axis PA of the reflective polarization film 100.

That is, the laser light L is emitted such that an angle of the polarization direction PD of the laser light L with respect to the polarization axis PA of the reflective polarization film 100 is larger than 0° and equal to or smaller than 90°. Accordingly, the sublimation efficiency of the metal vapor-deposition layer 104 because of the irradiation of the laser light L can be increased. As a result, the pattern formation in the reflective polarization film 100 can be efficiently performed.

A reference numeral B in FIG. 3 illustrates a case where the angle of the polarization direction PD of the laser light L with respect to the polarization axis PA of the reflective polarization film 100 is 90°. In other words, the polarization direction PD of the laser light L is orthogonal to the polarization axis PA of the reflective polarization film 100.

As the angle approaches 90°, the amount of heat supplied to the metal vapor-deposition layer 104 by the irradiation of the laser light L increases. Therefore, efficiency of the pattern formation in the reflective polarization film 100 can be further increased.

As the laser light L, yttrium aluminum garnet (YAG) laser light or YVO4 laser light can be used. Particularly, in the case of YAG laser light, since the metal vapor-deposition layer 104 has high absorption efficiency, a pattern can be formed efficiently.

A wavelength of the laser light L can be determined appropriately. Instead of the YAG laser light or the YVO4 laser light that is near-infrared light, visible laser light that is easily available and has a high cost-control effect may be used.

The reflective polarization film having the desired pattern formed by the above-described method can be mounted on, for example, a display apparatus.

FIG. 4 illustrates a configuration of such a display apparatus 1000. The display apparatus 1000 is driven by electric power supplied from an internal power supply such as a battery or electric power supplied from an external power supply such as a commercial power supply.

The display apparatus 1000 includes a first reflective polarization film 100A, a second reflective polarization film 100B, a first polarization member 200A, a second polarization member 200B, a first light source LS1, and a second light source LS2.

A direction of a polarization axis of the first reflective polarization film 100A and a direction of a polarization axis of the second reflective polarization film 100B are orthogonal to each other. That is, polarized light that passes through the first reflective polarization film 100A does not pass through the second reflective polarization film 100B. Similarly, polarized light that passes through the second reflective polarization film 100B does not pass through the first reflective polarization film 100A.

A first pattern 110A is formed in the first reflective polarization film 100A by the above-described processing method. Light incident on the first pattern 110A is allowed to pass therethrough regardless of a polarization direction thereof. A second pattern 110B is formed in the second reflective polarization film 100B by the above-described processing method. Light incident on the second pattern 110B is allowed to pass therethrough regardless of a polarization direction thereof.

A direction of a polarization axis of the first polarization member 200A and a direction of a polarization axis of the second polarization member 200B are orthogonal to each other. The direction of the polarization axis of the first polarization member 200A coincides with the direction of the polarization axis of the first reflective polarization film 100A. The direction of the polarization axis of the second polarization member 200B coincides with the direction of the polarization axis of the second reflective polarization film 100B. The first polarization member 200A and the second polarization member 200B may be an absorptive polarization member or a reflective polarization member.

The first polarization member 200A is disposed on a path of light emitted from the first light source LS1. The second polarization member 200B is disposed on a path of light emitted from the second light source LS2.

Each of the first light source LS1 and the second light source LS2 can be configured with at least one semiconductor light-emitting element that emits light of at least one color. Examples of the semiconductor light-emitting element include a light-emitting diode (LED), a laser diode (LD), and an organic EL element. Each of the first light source LS1 and the second light source LS2 may be a lamp light source such as a halogen lamp. Turning on/off each of the first light source LS1 and the second light source LS2 can be controlled by a processor (not shown) provided in the display apparatus 1000.

According to the display apparatus 1000 having such a configuration, by controlling light-emitting states of the first light source LS1 and the second light source LS2, the following three display states can be achieved.

(1) Display of Second Pattern 110B

When the first light source LS1 is in a light-emitting state and the second light source LS2 is in a non-light-emitting state, the first polarization member 200A only allows a polarization component parallel to the polarization axis of the first polarization member 200A to pass therethrough among light emitted from the first light source LS1.

Since the direction of the polarization axis of the first polarization member 200A coincides with the direction of the polarization axis of the first reflective polarization film 100A, polarized light that passes through the first polarization member 200A passes through the first reflective polarization film 100A.

Since the direction of the polarization axis of the second reflective polarization film 100B and the direction of the polarization axis of the first reflective polarization film 100A are orthogonal to each other, polarized light that passes through the first polarization member 200A and the first reflective polarization film 100A does not pass through the second reflective polarization film 100B. However, the second pattern 110B formed in the second reflective polarization film 100B allows passage of the polarized light.

Therefore, light that passes through the second pattern 110B can be visually recognized by the user. In other words, a shape of the second pattern 110B can be provided for display to the user.

(2) Display of First Pattern 110A

When the first light source LS1 is in a non-light-emitting state and the second light source LS2 is in a light-emitting state, the second polarization member 200B only allows a polarization component parallel to the polarization axis of the second polarization member 200B to pass therethrough among light emitted from the second light source LS2.

Since the direction of the polarization axis of the second polarization member 200B and the direction of the polarization axis of the first reflective polarization film 100A are orthogonal to each other, polarized light that passes through the second polarization member 200B does not pass through the first reflective polarization film 100A. However, the first pattern 110A formed in the first reflective polarization film 100A allows passage of the polarized light.

Since the direction of the polarization axis of the second polarization member 200B coincides with the direction of the polarization axis of the second reflective polarization film 100B, polarized light that passes through the second polarization member 200B and the first pattern 110A passes through the second reflective polarization film 100B.

Therefore, light that passes through the first pattern 110A can be visually recognized by the user. In other words, a shape of the first pattern 110A can be provided for display to the user.

(3) Display of First Pattern 110A and Second Pattern 110B

When both the first light source LS1 and the second light source LS2 are in a light-emitting state, the second pattern 110B is provided for display as described in above-described (1), and the first pattern 110A is provided for display as described in above-described (2).

Therefore, a plurality of reflective polarization films each having a pattern formed by the above-described processing method can be used so as to achieve a display apparatus that can switch a plurality of types of pattern display.

The first reflective polarization film 100A, the second reflective polarization film 100B, the first polarization member 200A, the second polarization member 200B, the first light source LS1, and the second light source LS2 do not need to be fixed at positions illustrated in FIG. 4. When an optical positional relationship illustrated in FIG. 4 can be achieved when displaying a desired pattern, a mechanism that can move at least one of the first reflective polarization film 100A, the second reflective polarization film 100B, the first polarization member 200A, the second polarization member 200B, the first light source LS1, and the second light source LS2 relative to the other can be provided.

The above-described embodiment is merely an example for facilitating understanding of the present disclosure. The configuration according to the above-described embodiment can be appropriately modified and improved without departing from the spirit of the present disclosure.

As an application target of the processing method according to the present disclosure, a reflective polarization film is illustrated as an example of a reflective polarization member.

However, the processing method according to the present disclosure can also be applied to pattern formation in a reflective polarization plate.

As an example of using the reflective polarization member having a pattern formed by the processing method according to the present disclosure, a case where the reflective polarization member is mounted on the display apparatus is shown. However, the reflective polarization member according to the present disclosure can be applied to various user interfaces in which a presented pattern can be changed depending on a situation.

As a part of the description of the present application, the contents of Japanese Patent Application No. 2018-115438 filed on Jun. 18, 2018, are incorporated.

1. A processing method for a reflective polarization member including a metal vapor-deposition layer that is configured to allow passage of light having a polarization component parallel to a polarization axis and to reflect light having a polarization component non-parallel to the polarization axis, the processing method comprising:
forming a region where the metal vapor-deposition layer is sublimated so as to have a shape corresponding to a desired pattern, by irradiating the reflective polarization member with laser light,
wherein a polarization direction of the laser light is a direction non-parallel to the polarization axis.

2. The processing method according to claim 1,
wherein a polarization direction of the laser light is a direction orthogonal to the polarization axis.

3. The processing method according to claim 1,
wherein the laser light is YAG laser light.

4. The processing method according to claim 1,
wherein the laser light is visible laser light.

5. A reflective polarization member including a metal vapor-deposition layer that is configured to allow passage of light having a polarization component parallel to a polarization axis and to reflect light having a polarization component non-parallel to the polarization axis,
wherein a region where the metal vapor-deposition layer is sublimated by laser light having a polarization component non-parallel to the polarization axis is shaped in a desired pattern.
